(19) United States
(12) Patent Application Publication
(10) Pub. No.: US 2025/0242535 A1
(43) Pub. Date: Jul. 31, 2025

(54) Extruder, Extruder Screw, and Method for Extruding

(71) Applicant: Irwin Research and Development, Inc., Yakima, WA (US)

(72) Inventor: Jere F. Irwin, Yakima, WA (US)

(73) Assignee: Irwin Research and Development, Inc., Yakima, WA (US)

(21) Appl. No.: 19/037,188

(22) Filed: Jan. 25, 2025

Related U.S. Application Data
(60) Provisional application No. 63/625,875, filed on Jan. 26, 2024.

(51) Int. Cl. B29C 48/85; B29C 48/395; B29C 48/525

(52) U.S. Cl. CPC B29C 48/85; B29C 48/397; B29C 48/525

(57) ABSTRACT

An extruder screw is provided having a screw body, a flight, and a heat transfer chamber. The screw body includes a shaft extending from an upstream end to a downstream end. The flight extends helically about the screw body. The heat transfer chamber is provided in the screw body having a thermodynamic heat sink mixture operative to transfer heat in an upstream direction of the screw. An extruder and a method of extruding are also provided.

### CROSS REFERENCE TO RELATED APPLICATIONS

This patent application claims the benefit of U.S. Provisional Patent Application Ser. No. 63/625,875, filed Jan. 26, 2024, entitled “Extruder, Extruder Screw, and Method for Extruding”, the disclosures of which are incorporated herein by reference.

### TECHNICAL FIELD

The present invention relates to polymer sheet formation. More particularly, the present invention pertains to a screw having a spiral flight for extruding and kneading a plastic elastomer, an extruder including the screw, and an extrusion method.

### BACKGROUND OF THE INVENTION

The field of extrusion, and more particularly, the field of thermoplastic sheet and foam extrusion, entails many techniques that are utilized in order to generate a uniform thickness product having desirable surface finish features and appropriate dimensional qualities. The ability to optimize heat placement along a screw in an extruder is a desirable feature needing improvement. There is also a need to reduce sticking of extruding material on a screw during operation.

### SUMMARY OF THE INVENTION

An extruder screw and an extruder are provided with a heat transfer chamber in the screw providing a heat sink. A method of extruding is also provided.

According to one aspect, an extruder screw is provided having a screw body, a flight, and a heat transfer chamber. The screw body includes a shaft extending from an upstream end to a downstream end. The flight extends helically about the screw body. The heat transfer chamber is provided in the screw body having a thermodynamic heat sink mixture operative to transfer heat in an upstream direction of the screw.

According to another aspect, an extruder is provided having a barrel, a screw body, a flight, and a heat transfer chamber. The screw body is carried for rotation within the barrel comprising a shaft extending from an upstream end to a downstream end. The flight extends helically about the screw body. The heat transfer chamber is provided in the screw body having a thermodynamic heat sink mixture operative to transfer heat along the screw body between an upstream end and a downstream end of the heat transfer chamber.

According to yet another aspect, a method is provided for extruding a plastic elastomer. The method includes: providing a barrel, a screw body supported in the barrel for rotation, a flight extending helically about the screw body, and a heat transfer chamber in the screw body; inserting plastic elastomer between the barrel and the screw body; rotating the screw body in the barrel to generate heat and melt the plastic elastomer; and temperature regulating a shaft of the screw body extending from an upstream end to a downstream end with a thermodynamic heat sink mixture provided in the screw body operative to transfer heat in an upstream direction of the screw.

### BRIEF DESCRIPTION OF THE DRAWINGS

FIG. 1 is a perspective, simplified view of an extruder with a screw of the present invention.

FIG. 2 is a downstream perspective view from above of a single stage extruder screw having an internal thermal circuit from the extruder of FIG. 1.

FIG. 3 is an upstream perspective view from above of the extruder screw of FIG. 2.

FIG. 4 is a side elevational view of the extruder screw of FIGS. 2 and 3.

FIG. 5 is a plan view from above of the extruder screw of FIG. 4.

FIG. 6 is an upstream end view of the extruder screw of FIG. 5.

FIG. 7 is a vertical centerline sectional view broken into three parts of the extruder screw taken along line 7-7 of FIG. 6.

FIG. 8 is an enlarged partial vertical centerline sectional view about the heat transfer circuit in the extruder screw containing a thermodynamic phase changing heat sink liquid/gas mixture.

FIG. 9 is a further enlarged partial vertical centerline sectional view of an upstream end of the heat transfer circuit showing a first fluid closure with an access port and a plug of FIG. 8.

FIG. 9A is an enlarged partial vertical centerline sectional view of the fluid closure from encircled region 9A of FIG. 9.

FIG. 10 is a further enlarged partial vertical centerline sectional view of an upstream end of the heat transfer circuit showing a second fluid closure over that shown in FIG. 9.

FIG. 10A is an enlarged partial vertical centerline sectional view of the alternative second fluid closure from encircled region 10A of FIG. 10.

FIG. 11 is a further enlarged partial vertical centerline sectional view of an upstream end of the heat transfer circuit showing a third fluid closure over that shown in FIG. 9.

FIG. 11A is an enlarged partial vertical centerline sectional view of the alternative third fluid closure from encircled region 11A of FIG. 11.

FIG. 12 is a further enlarged partial vertical centerline sectional view of an upstream end of the heat transfer circuit showing a fourth fluid closure over that shown in FIG. 9.

FIG. 12A is an enlarged partial vertical centerline sectional view of the alternative fourth fluid closure from encircled region 12A of FIG. 12.

FIG. 13 is a simplified and diagrammatic enlarged partial vertical centerline sectional view about the heat transfer circuit in the extruder screw containing a thermodynamic phase changing heat sink liquid/gas mixture and showing endothermic and exothermic phase change regions with heat transfer.

FIG. 14 is a perspective view from above and downstream of a single screw extruder having the screw of FIGS. 1-9 and 13.

FIG. 15 is a plan view from above of the single screw extruder of FIG. 13.

FIG. 16 is a left side elevational view of the single screw extruder of FIG. 13.

FIG. 17 is a vertical upstream end view of the single screw extruder of FIG.>15.

FIG. 18 is a vertical centerline sectional view of the extruder taken along line 18-18 of FIG. 17 and further showing a control system with temperature and pressure sensor signal lines, fluid and electric heater signal lines, and gas injection port signal lines for the extruder.

FIG. 19 is an enlargement of one clamp used to join together adjacent heater jacket sections of the extruder taken from encircled region 19 of FIG. 18.

FIG. 20 is a Table listing one suitable formulation for the oxygen scavenging and rust preventing thermodynamic phase changing heat sink liquid/gas mixture of FIGS. 8 and 13.

FIG. 21 is a left side elevational view of an alternative constructed single screw extruder over that depicted in FIGS. 1-20.

FIG. 22 is a vertical centerline sectional view of the extruder of FIG. 21 taken along line 22-22 of FIG. 21.

### DETAILED DESCRIPTION OF THE ILLUSTRATED EMBODIMENTS

This disclosure of the invention is submitted in furtherance of the constitutional purposes of the U.S. Patent Laws “to promote the progress of science and useful arts” (Article 1, Section 8).

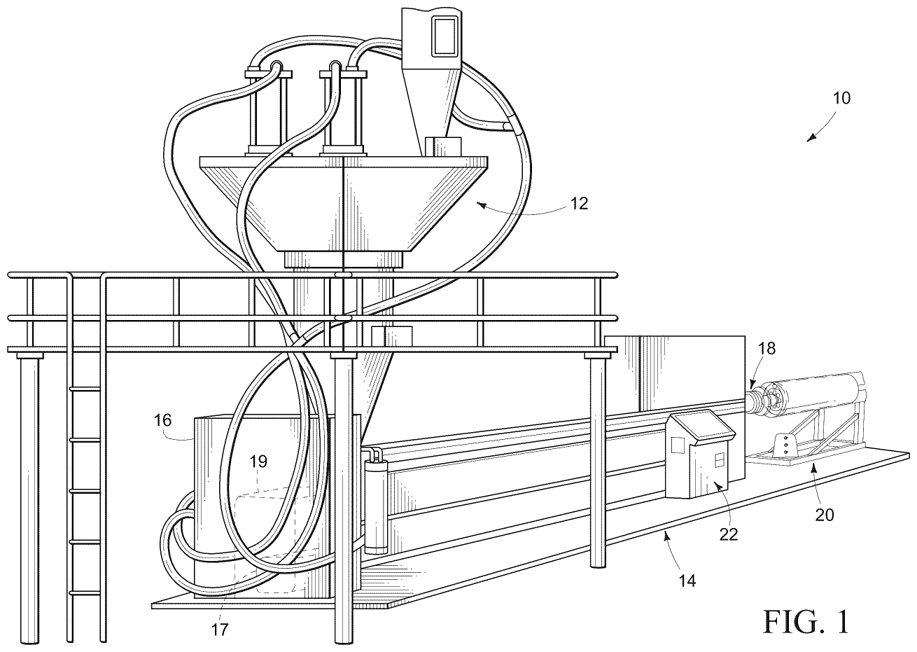

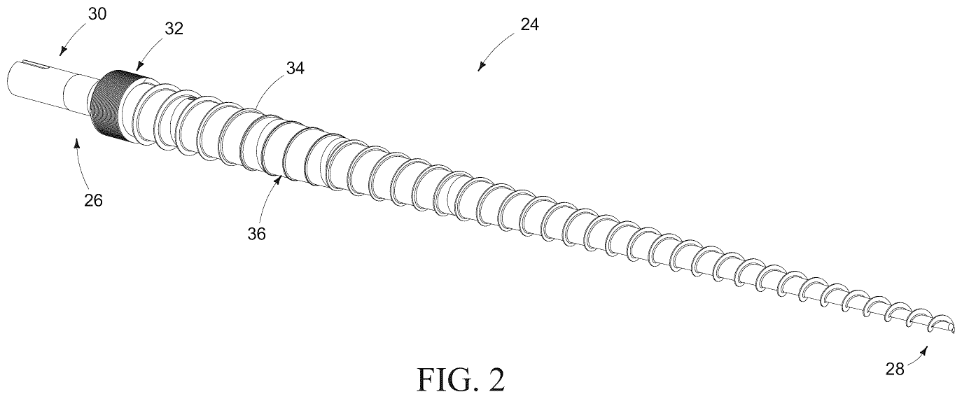

Reference will now be made to preferred embodiments of Applicant's invention comprising an extruder 14 of an extrusion line 10 having an extruder screw 24 (see FIG. 2) as shown in FIG. 1. While the invention is described by way of certain embodiments, it is understood that the description is not intended to limit the invention to such embodiments. but is intended to cover alternatives, equivalents, and modifications which may be broader than the embodiments, but which are included within the scope of the appended claims.

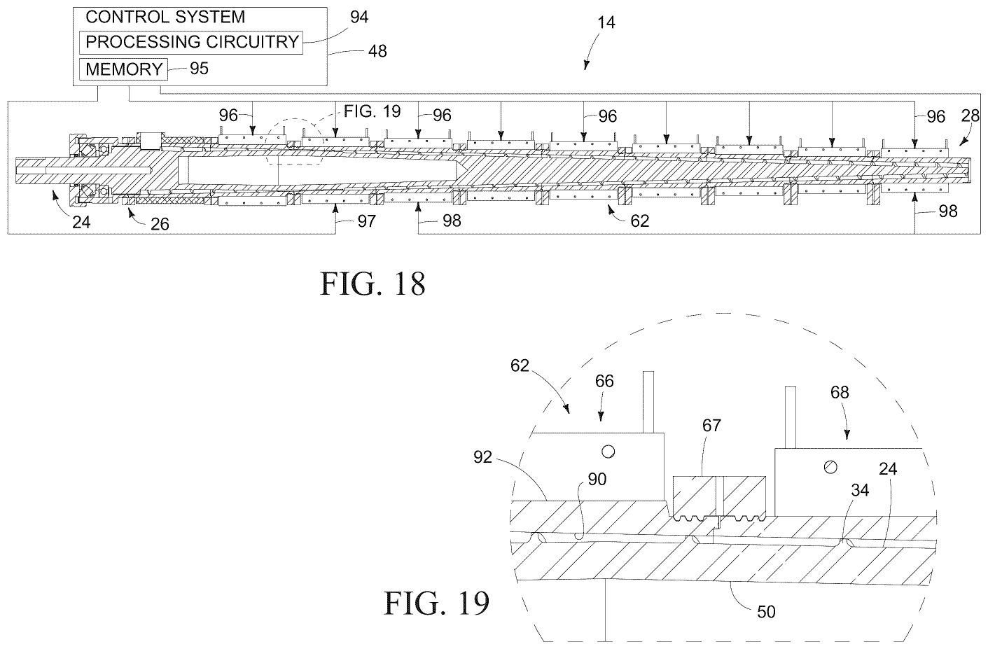

FIG. 1 is a perspective, simplified view of an extruder 14 with a screw 24 (FIG. 2) of the present invention provided in an extrusion line 10. A hopper 12 feeds product into an upstream end of extruder 14. A motor drive assembly 16 includes an electric drive motor 17 and a gearbox that drive a shaft of extruder 14 in rotation. An annular extruder die assembly 18 is provided at a downstream exit end of single stage extruder 14 upstream of a sizing can 20 about which a tube of extruded plastic or foamed plastic material is delivered, sized and cooled. A control system cabinet 22 housing a user interface and control system 48 (see FIG. 18).

FIG. 2 is a downstream perspective view from above of a single stage extruder screw 24 having an internal thermal circuit, or heat sink phase change chamber 50 provided within the extruder 14 of FIG. 1. Extruder screw 24 has a keyed drive shaft 30 at an upstream end 26 and extends in decreasing diameter towards a downstream end 28. A helical flight, or thread 34 extends along a staged, tapering shaft 36 from a threaded enlarged cylindrical shoulder 32 at upstream end 26 to downstream end 28.

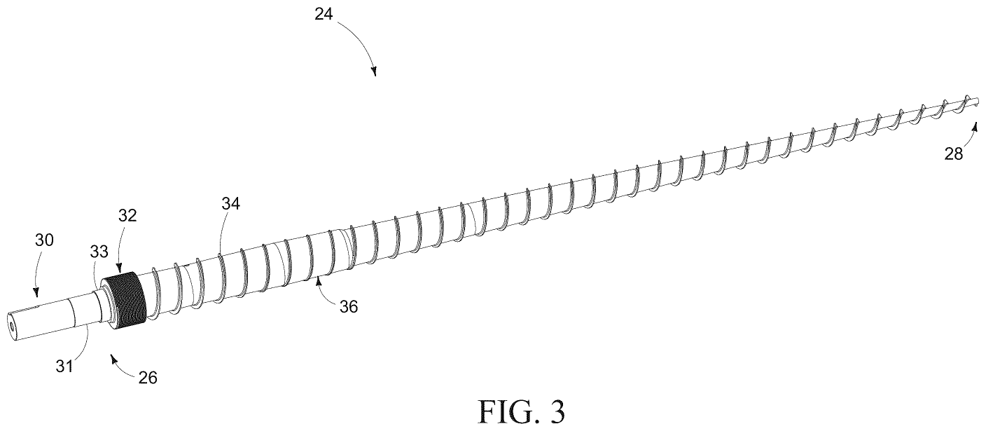

FIG. 3 is an upstream perspective view from above of the extruder screw 24 of FIG. 2 further showing drive shaft 30 adjacent a roller bearing shoulder 31 and a tapered bearing shoulder 33 along upstream end 26 and upstream of cylindrical threaded shoulder 32. Flight 34 extends helically from upstream end 26 to downstream end 28 along shaft 36.

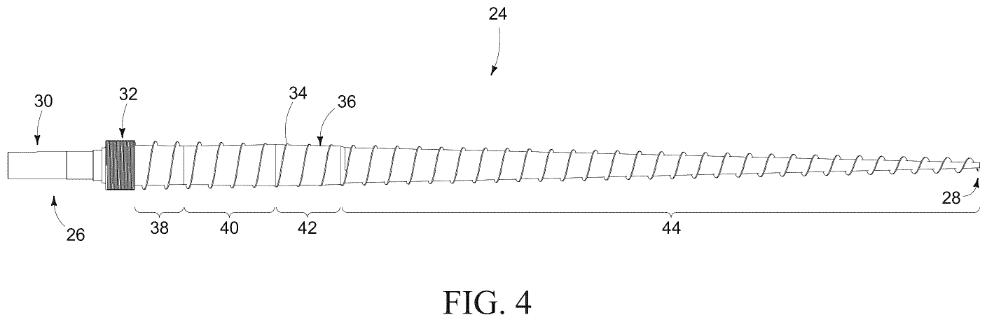

FIG. 4 is a side elevational view of the extruder screw 24 of FIGS. 2 and 3 showing distinct transitional segments along shaft 35 as flight 3 extends from upstream end 26 to downstream end 28. Cylindrical threaded shoulder 32 is provided upstream of flight 34 and prevents upstream migration on any plastic product upstream of shoulder 32. Segment 38 of shaft 36 tapers down in diameter moving from an upstream end to a downstream end, whereas segment 40 tapers up in diameter. Segments 42 and 44 each taper in a downward direction. According to one construction shaft 36 is constructed from one or more pieces of hardened carbon steel. However, any optional structural material can be used including stainless steel, steel, aluminum, metal alloys or composite materials. It is further understood that a multiple stage screw arrangement can be used. It is even further understood that any combination of straight, tapering down, tapering up, concave or convex segments can be used on one or more screws. The screw 24 of FIG. 4 is designed for a tapered barrel, but it is understood that a constant diameter barrel can be used with changes occurring in the flights as they progress down the barrel and tapering of the screw shaft.

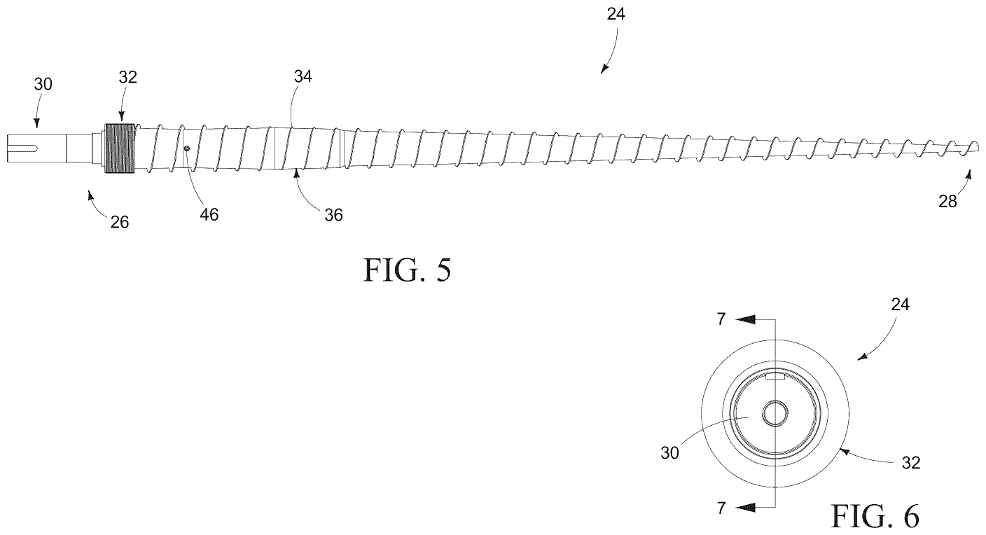

FIG. 5 is a plan view from above of the extruder screw 24 of FIG. 4 showing a fluid closure 46 located on shaft, or body 36 between adjacent portions of flight 34. Closure 46 is provided to insert a phase changing oxygen scavenger liquid mixture within a chamber internal of screw 24. In some cases, such liquid mixture will operate solely as a vapor, in other cases as a vapor/liquid mixture, and in some other cases as a liquid. Shaft 30 is driven by a motor and gearbox to rotate screw 24 such that flight 34 moves plastic material from an upstream end 26 to a downstream end 28 to melt such plastic material within a barrel of an extruder. A fine thread, or flight on shoulder 32 prevent migration of plastic material in an upstream direction during operation.

FIG. 6 is an upstream end view of the extruder screw 24 of FIG. 5. Drive shaft 30 is formed coaxially of shoulder 32.

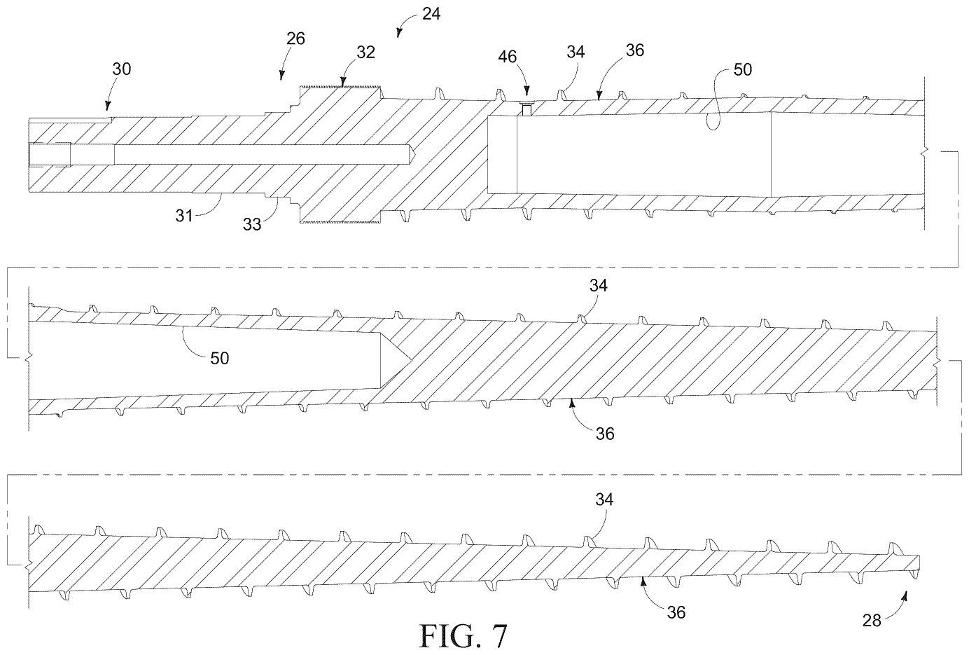

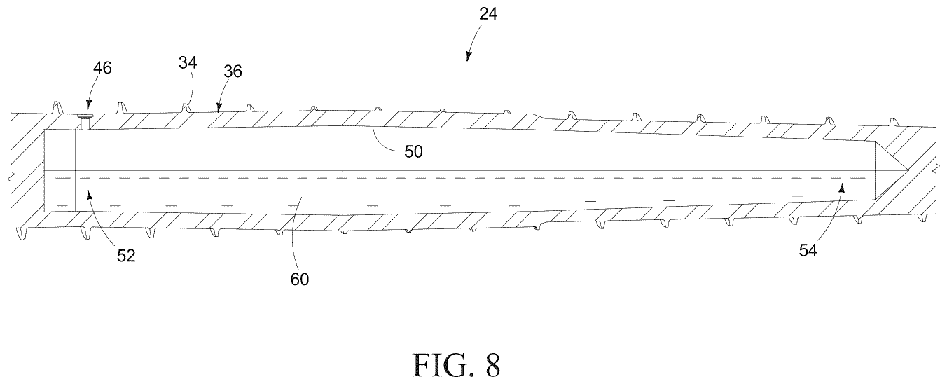

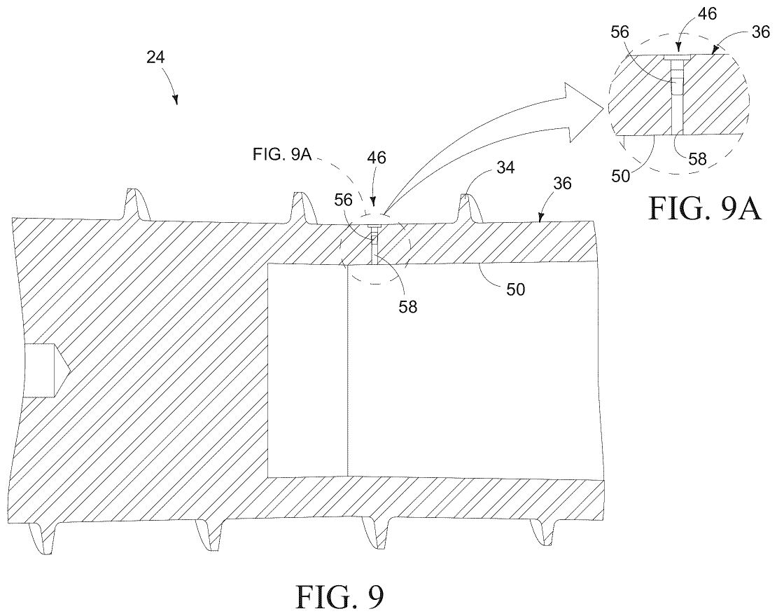

FIG. 7 is a vertical centerline sectional view broken into three parts of the extruder screw 24 taken along line 7-7 of FIG. 6. More particularly, a phase changing heat transfer circuit, or heat sink chamber 50 is shown within shaft 36 configured to receive a phase changing oxygen starving fluid mixture 60 (see FIG. 8). The outer diameter of shaft, or core 36 changes depending on location extending from an upstream end 26 to a downstream end 28 and flight, or thread 34 also changes in overall height to match an inner diameter of a barrel in which screw 24 is being rotated with plastic material during an extruding operation. Roller bearing shoulder 31, tapered bearing shoulder 33, and threaded shoulder 32 are shown downstream of drive shaft 30 on shaft 36. Fluid closure 46 is shown without plug 56 (see FIG. 9A).

FIG. 8 is an enlarged partial vertical centerline sectional view about the heat transfer circuit, or heat transfer chamber 50 formed within the extruder screw 24 containing a thermodynamic phase changing heat sink liquid/gas mixture shown here in a cool pre-operation state as a liquid 60. Fluid closure 46 is shown with a plug removed after inserting liquid mixture 60 into chamber 50 extending from an upstream end 52 to a downstream end 54. Flight 34 varies in height from an outer surface of shaft 36 depending on location along shaft 36. One of the plugs shown in FIGS. 9-12 is inserted to seal fluid closure 46 after insertion of mixture 60 (composition detailed in FIG. 19).

Screw 24 in FIG. 8 transfers downstream heat in screw 24 in an upstream direction which heats flight 34 and an outer surface of shaft 36 to a higher temperature in an upstream direction. The principle is to heat screw 24 so that the extruding material will slip on screw 24 and not stick. In a typical extruder operation, the barrel 62 (see FIG. 17) is heated or cooled to make sure the material sticks and does not slip. The reason for this is that the material feeds through from an upstream direction to a downstream direction. If screw 24 is too cool, the extruding material will stick and not feed. The reason for drawing heat back, or upstream to the start of screw 24 is to make the screw 24 feed better and be more energy efficient. In addition, in some cases a lower friction coating is applied to an outer surface of screw 24 on flight 34 and shaft 36. For example, a titanium coating can be applied. Optional lower friction coatings might be a ceramic coating or some other suitable coating or plating that reduces friction and stickiness.

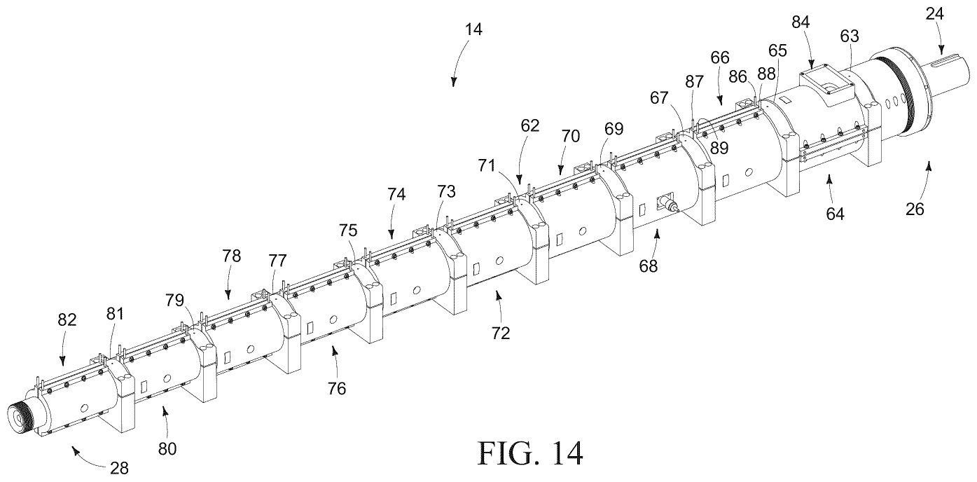

As shown in FIGS. 7 and 8, elongate central chamber 50 can be located more leftward or rightward of that shown in FIGS. 7 and 8, and can be more elongate or less elongate than shown. Infeed chute 84 (see FIG. 14) provides a feed chute for introducing virgin and/or recycled material. As shown in FIG. 7, a central elongate internal bore is provided in shaft 36 in the region of shoulders 31-33 and can provide cooling to shaft 36 via air, or introduction of a liquid cooling circuit, or cooling fluid provided within such central internal bore (not shown). As shown in FIG. 8, chamber 50 is filled with liquid mixture 60 to approximately 50% volume according to one construction. However, another construction has a volume fill of chamber 50 with liquid mixture 60 of from 5% to 80%. Yet another construction has a volume fill of chamber 50 with liquid mixture 60 of from 20% to 40%. Other percentages are possible depending on constituents of liquid mixture 60, size and placement of chamber 50, and geometry and operating temperatures of screw 36.

FIG. 9 is a further enlarged partial vertical centerline sectional view of an upstream end of the heat transfer circuit, or chamber 50 inside of screw 24 and showing first fluid closure 46 having a first access port 58 and a plug 56 used in FIG. 8. As shown in FIG. 9, plug 56 is a Lee plug expansion plug. Port 58 extends from an outer surface of shaft 36 to an inner surface defining chamber 50.

FIG. 9A is an enlarged partial vertical centerline sectional view of the fluid closure 46 from encircled region 9A of FIG. 9 further showing the first access port 58 in shaft 36 and the Lee plug expansion plug 56. Port 58 extends between an outer surface of shaft 36 and an inner surface defining chamber 50.

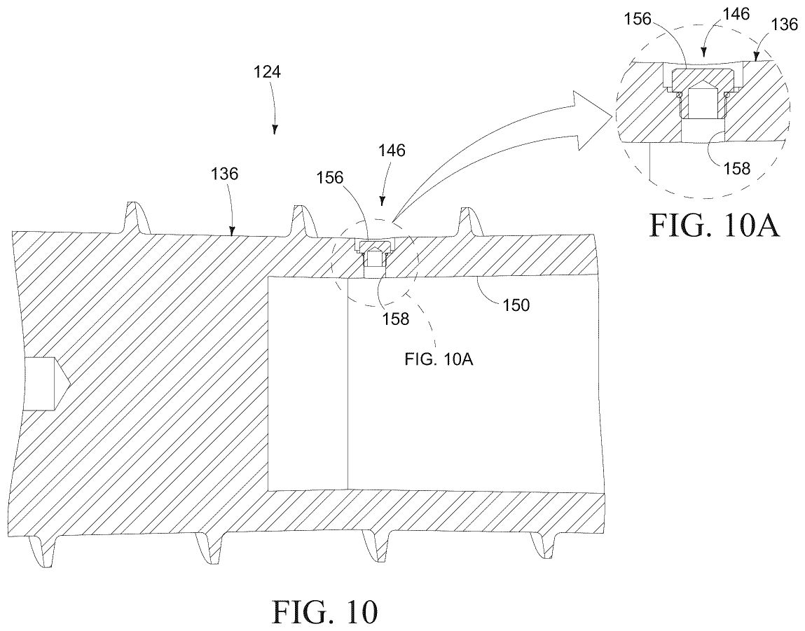

FIG. 10 is a further enlarged partial vertical centerline sectional view of an upstream end of a heat transfer circuit, or chamber 150 inside of a shaft 136 showing a second alternative fluid closure 146 over that shown in FIG. 9 having an access port 158 in shaft 136 of a screw 124 and a sealed hydraulic plug 156 that has threads and an o-ring seal.

FIG. 10A is an enlarged partial vertical centerline sectional view of the alternative second fluid closure 146 from encircled region 10A of FIG. 10 showing plug 156 inserted in sealed relation within port 158 in shaft 136.

FIG. 11 is a further enlarged partial vertical centerline sectional view of an upstream end of the heat transfer circuit, or chamber 250 in a shaft 236 showing a third closure 246 (see FIG. 11A) over that shown in FIG. 9 having an access port 258 and a sealed pipe plug 256 providing access to chamber 250.

FIG. 11A is an enlarged partial vertical centerline sectional view of the alternative third fluid closure 246 from encircled region 11A of FIG. 11 showing port 258 in shaft 236 and plug 256.

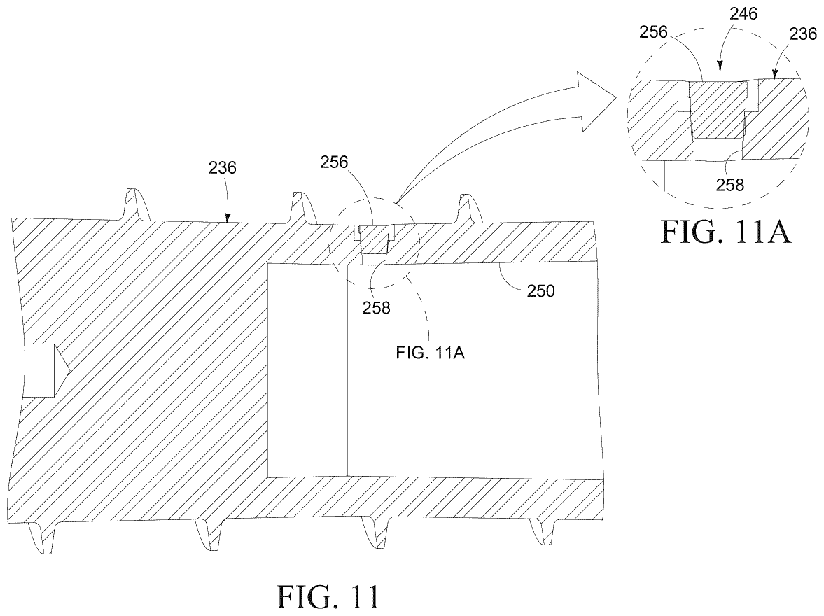

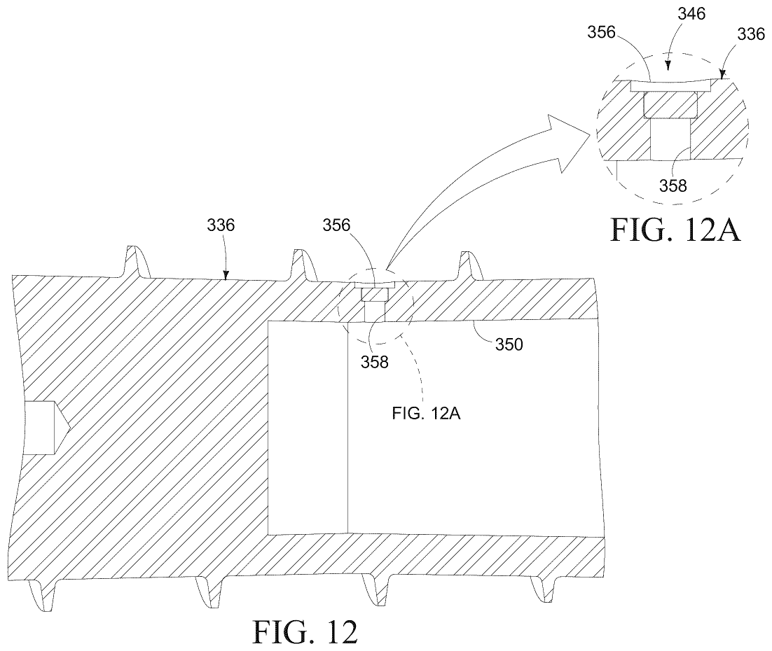

FIG. 12 is a further enlarged partial vertical centerline sectional view of an upstream end of the heat transfer circuit, or chamber 350 showing a fourth fluid closure 346 (see FIG. 12A) having an access port 358 and a welded steel closure plug 356 over that shown in FIG. 9.

FIG. 12A is an enlarged partial vertical centerline sectional view of the alternative fourth fluid closure 346 from encircled region 12A of FIG. 12 where port 358 is provided in shaft 336 and a cylindrical steel plug 356 is welded into a recess above port 358 after introducing oxygen starving fluid mixture into chamber 350 (see FIG. 12).

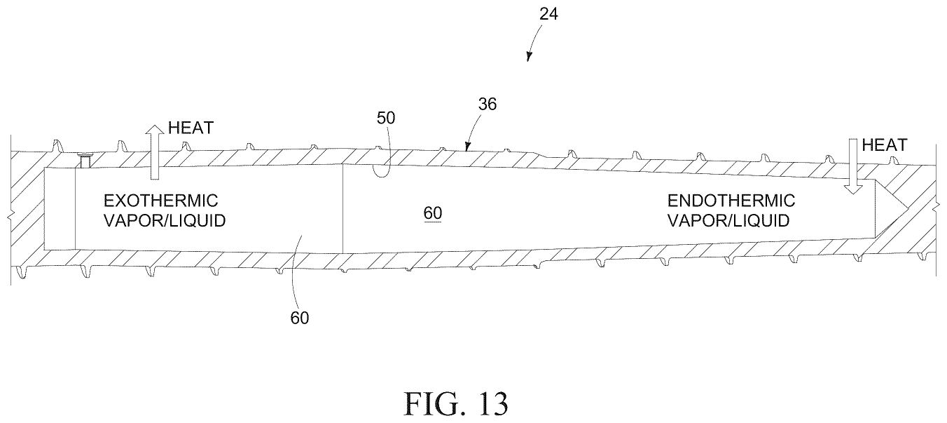

FIG. 13 is a simplified and diagrammatic enlarged partial vertical centerline sectional view about the heat transfer circuit, or chamber 50 in the shaft 36 of the extruder screw 24 containing a thermodynamic phase changing heat sink liquid/gas mixture 60 and showing endothermic and exothermic phase change regions with heat transfer. Water has a higher specific heat capacity than steel making it better at storing and retaining heat energy. Water is a better heat sink than steel (high specific heat capacity). That means water makes a better heat sink for pulling heat out of the hot end of the screw, the phase change further helps pull the heat, and the reverse phase change at the other end releases that heat. Screw 36 rotates within a stationary wall, or surface 90 (see FIG. 19) of a stationary barrel 62 (see FIG. 14) which generates heat via friction in operation delivered to screw 36, and chamber 50 imparts cooling along screw 36 from endothermic and exothermic phase change regions within chamber 50 from mixture 60. Optionally, mixture 60 can provide general cooling to screw 36 during operation irrespective of any phase changes.

FIG. 14 is a perspective view from above and downstream of a single screw extruder 14 having the screw 24 of FIGS. 1-9 and 13. Barrel 62 includes clamps 63, 65, 67, 69, 71, 73, 77, 79 and 81, as well as jackets 64, 66, 68, 70, 72, 74, 76, 78, 80 and 82. Jacket 64 provides an infeed chute 84 that connects with hopper 12 (see FIG. 1). Jackets 66, 68, 70, 72, 74, 76, 78, 80 and 82 each provide a distinct thermal regulation jacket having a fluid heating tubing circuit extending between a fluid inlet port 86 and a fluid outlet port 87 and an electrical resistive heating element having a first electrical lead 88 and a second electrical lead 89. Such jackets 64, 66, 68, 70, 72, 74, 76, 78, 80 and 82 extend between an upstream end 26 and a downstream end 28 along screw 24.

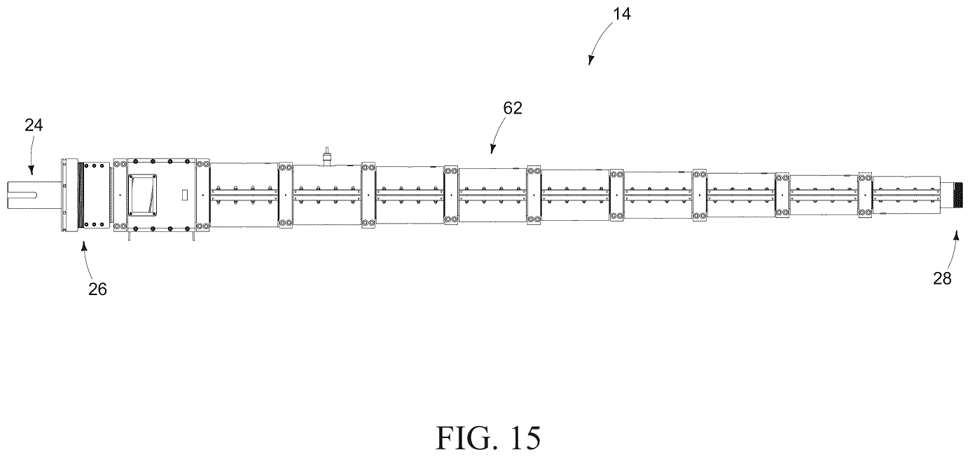

FIG. 15 is a plan view from above of the single screw extruder 14 of FIG. 13. Screw 24 is configured to be rotated within barrel 62 extending from an upstream end 26 to a downstream end 28.

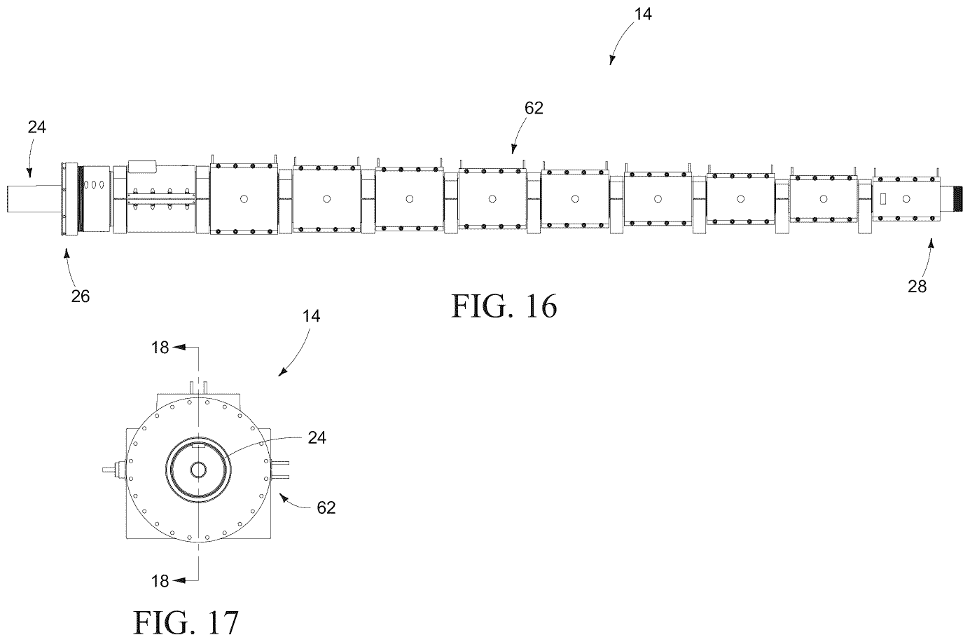

FIG. 16 is a left side elevational view of the single screw extruder 14 of FIG. 13. More particularly, screw 24 extends within barrel 62 between an upstream end 26 and a downstream end 28.

FIG. 17 is a vertical upstream end view of the single screw extruder 14 of FIG. 15. showing the screw 24 positioned coaxially within the barrel 62.

FIG. 18 is a vertical centerline sectional view of the extruder 14 taken along line 18-18 of FIG. 17 and further showing a control system 48 having processing circuitry 94 and memory 95 with temperature and pressure sensor signal lines 98, fluid (cold) and electric heater (hot) signal lines 96, and a gas injection port signal line 97 for the extruder 14 extending along barrel 62. Screw 24 extends within barrel 62 for rotation from an upstream end 26 to a downstream end 28.

FIG. 19 is an enlargement of one clamp 67 used to join together adjacent heater jacket sections 66 and 68 of the extruder taken from encircled region 19 of FIG. 18. Barrel 62 includes a barrel body 92 having an inner diameter bore 90. Screw 24 rotates along inner surface 90 with flight 34. Chamber 50 provides a heat transfer mechanism along the screw 24 that optimizes thermal performance.

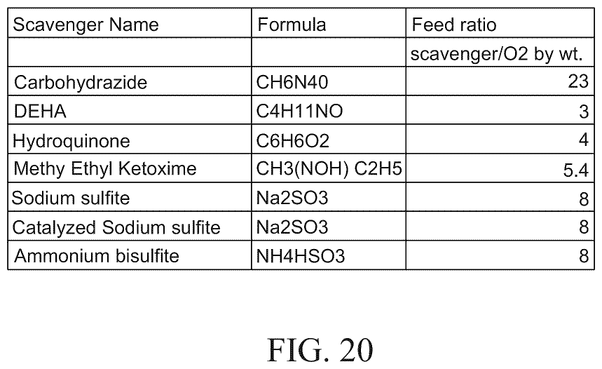

FIG. 20 is a Table listing one suitable formulation for the oxygen scavenging and rust preventing thermodynamic phase changing heat sink liquid/gas mixture of FIGS. 8 and 13. The admixture of the Table in FIG. 20 is then added to water at a level sufficient to eliminate oxygen from the liquid mixture.

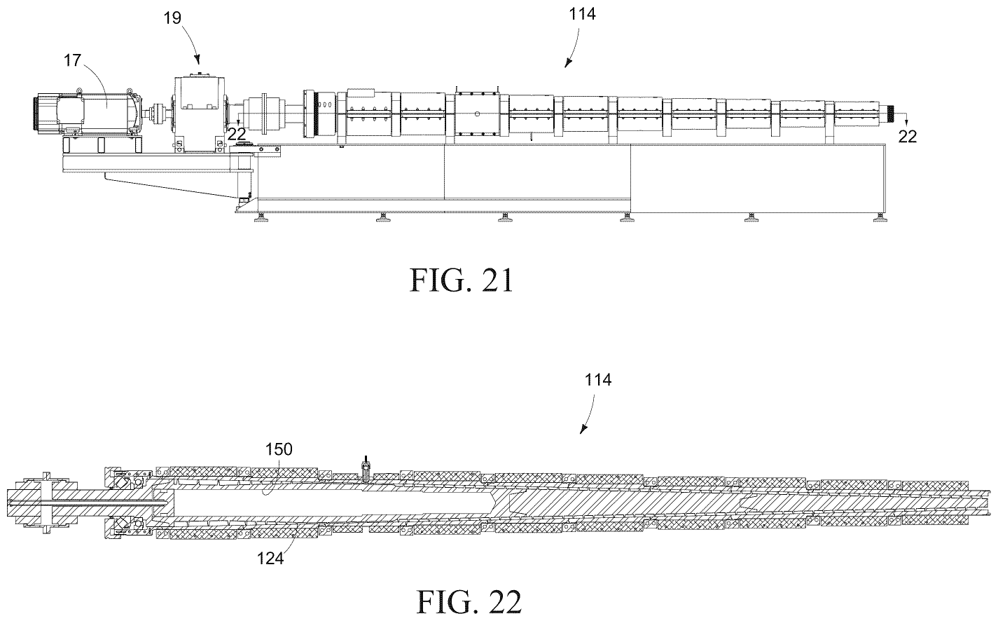

FIG. 21 is a left side elevational view of an alternative constructed single screw extruder 114 over that depicted in FIGS. 1-20. A drive motor 17 and a gearbox 19 are also shown.

FIG. 22 is a vertical centerline sectional view of the extruder 114 of FIG. 21 taken along line 22-22 of FIG. 21. Chamber 150 is shown inside screw 124 with a plug provided concentrically in an upstream end.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

What is claimed is:

1. An extruder screw, comprising:
a screw body comprising a shaft extending from an upstream end to a downstream end;
a flight extending helically about the screw body; and
a heat transfer chamber provided in the screw body having a thermodynamic heat sink mixture operative to transfer heat in an upstream direction of the screw.

2. The extruder screw of claim 1, wherein the shaft comprises an access port communicating with the heat transfer chamber and a closure configured to secure and seal the access port.

3. The extruder screw of claim 1, wherein the flight comprises a thread having a radial dimension sized to conform with changes in overall height to substantially match an inner diameter of a barrel in which the screw is housed and being rotated.

4. The extruder screw of claim 1, wherein the heat transfer chamber comprises a phase changing heat transfer circuit including the thermodynamic heat sink mixture contained in the heat transfer chamber.

5. The extruder screw of claim 4, wherein an upstream end of the chamber contains an exothermic vapor/liquid phase change to the thermodynamic heat sink mixture and a downstream end of the chamber provides an endothermic vapor/liquid phase change. to the thermodynamic heat sink mixture.

6. The extruder screw of claim 1, wherein the thermodynamic heat sink mixture provided within the heat transfer chamber comprises an oxygen scavenging and rust preventing thermodynamic phase changing heat sink liquid and gas mixture.

7. The extruder screw of claim 6, wherein the scavenging liquid comprises one of: a carbohydrazide, DEHA, hydroquinone, methylethy ketone oxime, sodium sulfite, catalyzed sodium sulfite, and ammonium bisulfite.

8. The extruder screw of claim 1, wherein the screw body comprises steel.

9. The extruder screw of claim 8, wherein the steel screw comprises a hardened carbon steel.

10. The extruder screw of claim 1, wherein the screw body comprises one of a a stainless steel, a steel, an aluminum, a metal alloy or a composite material.

11. The extruder screw of claim 1, wherein the screw body of the extruder screw is a single stage screw body.

12. An extruder, comprising:
a barrel;
a screw body carried for rotation within the barrel comprising a shaft extending from an upstream end to a downstream end;
a flight extending helically about the screw body; and
a heat transfer chamber provided in the screw body having a thermodynamic heat sink mixture operative to transfer heat along the screw body between an upstream end and a downstream end of the heat transfer chamber.

13. The extruder of claim 12, wherein the thermodynamic heat sink mixture comprises a liquid configured to change between the liquid and a gas within the heat transfer chamber.

14. The extruder of claim 13, wherein the thermodynamic heat sink mixture transforms from a gas to a liquid and condenses along the upstream end of the heat transfer chamber.

15. The extruder of claim 12, wherein the thermodynamic heat sink mixture transforms from a liquid to a gas and boils along the downstream end of the heat transfer chamber.

16. The extruder of claim 12, wherein the thermodynamic heat sink mixture provided within the heat transfer chamber comprises an oxygen scavenging and rust preventing thermodynamic phase changing heat sink liquid and gas mixture.

17. A method of extruding a plastic elastomer, comprising:
providing a barrel, a screw body supported in the barrel for rotation, a flight extending helically about the screw body, and a heat transfer chamber in the screw body;
inserting plastic elastomer between the barrel and the screw body;
rotating the screw body in the barrel to generate heat and melt the plastic elastomer; and
temperature regulating a shaft of the screw body extending from an upstream end to a downstream end with a thermodynamic heat sink mixture provided in the screw body operative to transfer heat in an upstream direction of the screw.

18. The method of claim 17, further comprising generating an exothermic vapor to liquid transformation of the thermodynamic heat transfer mixture along an upstream end of the heat transfer chamber.

19. The method of claim 17, further comprising generating an endothermic liquid to vapor transformation of the thermodynamic heat transfer mixture along a downstream end of the heat transfer chamber.

20. The method of claim 18, wherein the thermodynamic heat sink mixture comprises a liquid and further comprising phase changing between the liquid and a gas.
